(19) United States
(12) Patent Application Publication
(10) Pub. No.: US 2004/0205705 A1
(43) Pub. Date: Oct. 14, 2004

(54) SYSTEM SUPPORT CODE

(75) Inventor: Gregory Lee Harrington, Pflugerville, TX (US)

Correspondence Address: Robert V. Wilder, Attorney at Law, 4235 Kingsburg Drive, Round Rock, TX, 78681, US

(73) Assignee: International Business Machines Corporation, Armonk, NY (US)

(21) Appl. No.: 09/737,007

(22) Filed: Dec. 14, 2000

(51) Int. Cl. G06F 9/44

(52) U.S. Cl. 717/110

(57) ABSTRACT

A method and implementing system are provided in which, in an exemplary embodiment, application programs are modified using supported developer's kits to be compatible with referenced prior coded versions. Pages presented in an application are processed, and functional features are separated from non-functional or cosmetic features. The failing cosmetic features are removed, and functional features are re-coded to provide a functionally equivalent application based upon a supporting referenced code.

### FIELD OF THE INVENTION

The present invention relates generally to information processing systems and more particularly to a methodology and implementation for re-coding applications in distributed and other network systems.

### BACKGROUND OF THE INVENTION

The continually increasing use and development of networks, including the Internet as well as local area networks (LANs), has created a massive communication system in which any one computer machine or system is able to communicate with almost any other machine in any country of the world. The term “machine” as used herein refers to computer systems which may be operating as user terminals or network servers. The evolution of networks and computer systems has also created an environment in which many different operating systems and computer machines exist and each machine needs to be able to have access to other machines which in many cases have different operating systems. Moreover, each different operating system will have application programs created to work specifically with that particular operating system. Programs written to operate with one operating system may not have corresponding programs written to operate on different operating systems.

Through the use of inter-connected networked systems, users on one system are able to have access to and utilize resources which are available on machines located elsewhere in the network. However, current web-based password reset tools can only be installed on certain operating systems. For example, an existing version of “HelpNow! EasyAccess 2.0™” (HNEA) can only be installed on a server running Microsoft Windows NT 4.0™, and the server clients are only clients running Windows 95™, Windows 98™, Windows NT™ and Windows 2000™ operating systems. HNEA operates as web-based password reset tool to reset the passwords of user IDs that are created in Windows NT and Windows 2000, HPUX™, AIX™, Sun Solaris™, MVS™ and Novell Netware™ systems. Even though the end user must have a user ID to log on to the HNEA application, the user ID of each networking environment already exists independently of the HNEA application. Only the user ID of the HNEA application is created from HNEA. The other user IDs are created in their own respective environments. For example, the user ID of an AIX environment must be created on AIX, not HNEA.

HNEA was developed to use Microsoft Internet Information Server (IIS), and IIS cannot be installed on an OS/2 system. That problem is avoided by developing HNEA to use Lotus Domino™ program as a web server. However, when OS/2 end users access the HNEA web application from their versions of their OS/2 browsers (such as Netscape Communicators 4.61 for OS/2), the web pages are displayed incorrectly.

Thus, there is a need for an improved system and methodology for aligning various versions of network application programs to run on OS/2 systems.

### SUMMARY OF THE INVENTION

A method and implementing system are provided in which, in an exemplary embodiment, application programs are modified using a supported developer's kit to be compatible with earlier-version code references. Pages presented in the application are processed, and functional features are separated from non-functional or cosmetic features. The failing cosmetic features are removed, and a functionally equivalent application is provided.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration of an exemplary network system;

FIG. 2 is a schematic diagram of an exemplary computer system;

FIG. 3 is a flowchart illustrating an exemplary methodology implemented in one embodiment of the present invention; and

FIG. 4 is a flowchart illustrating the exemplary methodology in greater detail.

### DETAILED DESCRIPTION

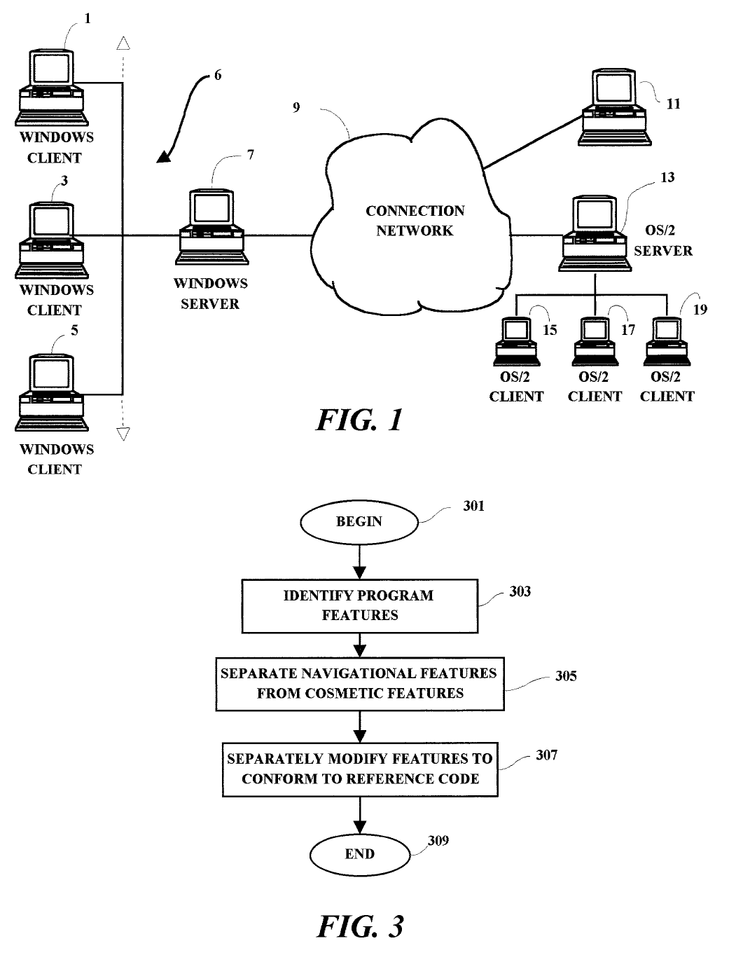

The various methods discussed herein may be implemented within an exemplary distributed information processing system as illustrated in FIG. 1. As shown, an exemplary information processing system includes first, second and third computer machines 1, 3 and 5, which are connected together in a first network configuration 6 and coupled to a network server 7. The network server 7 is, in turn, connected through a connection network 9, to one or more remote computer systems 11 and 13. Computer systems 11 and 13 may, for example, be servers at remote network sites and the connection network 9 may be the Internet. In the example, the server 13 is an OS/2 system and is connected to OS/2 client or user terminals 15, 17 and 19. In the illustrated example, server 7 is operating a Windows operating system and client or user terminals 1, 3 and 5 are also running Windows systems.

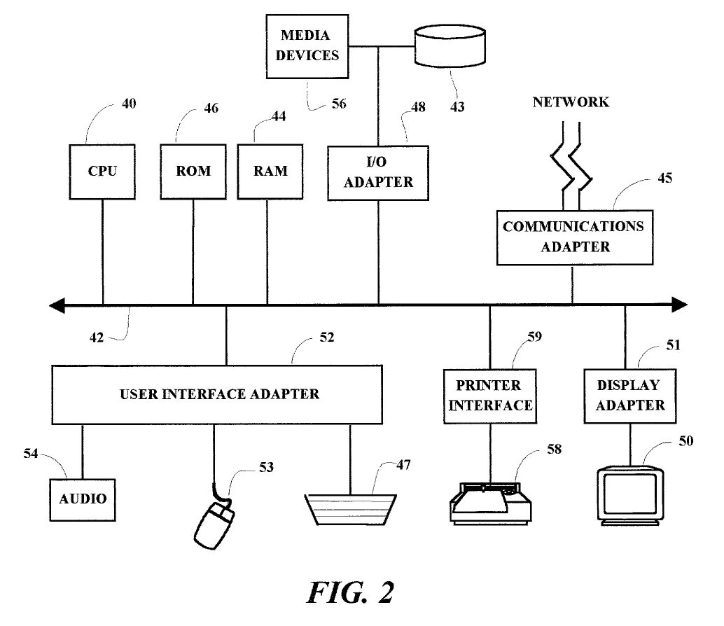

Referring to FIG. 2, there is shown a pictorial representation of an exemplary server computer system or workstation having a central processing unit (CPU) 40 such as a conventional microprocessor, and a number of other units interconnected via a system bus 42. The exemplary workstation shown in FIG. 2 further includes a Random Access Memory (RAM) 44, a Read-Only Memory (ROM) 46, an input/output (I/O) adapter 48 for connecting peripheral devices such as storage unit 43 and one or more media devices 56 (such as floppy disks and CDs) to the bus 42. A user interface adapter 52 is shown connecting a keyboard 47, a mouse 53 and an audio system 54 (which may include speakers and microphones) to the bus 42. Other devices may also be connected to the bus 42 through the user interface adapter 52. A communications adapter 45 is shown in the example connecting the bus 42 to one or more networks, and a display adapter 51 connects a display device 50 to the main bus 42. The computer software embodiment of the present invention may be included as software installed on one of the workstations within the distributed environment illustrated. One skilled in the art will appreciate that the procedures associated with the present invention may be in the form of a computer program product on a computer readable medium, which may be temporarily or permanently loaded on the illustrated workstation from media devices 56 such as CD or floppy diskettes, and also from storage devices such as hard drive 43, and executed from RAM memory 44.

As hereinbefore noted, when OS/2 end users access the HNEA web application from their versions of their OS/2 browsers (such as Netscape Communicator™ 4.61 for OS/2), the web pages are displayed incorrectly. This is so because the OS/2 browser does not thoroughly understand the programming language that was used, and cannot compile the version that is used by HNEA, such as JavaScript™ 1.2. Furthermore, the failure to display the web page properly is the result of Java™ 1.2 not being supported on the OS/2 browsers.

To solve this problem, HNEA is re-coded by using the supported developer's kits, IBM™ OS/2™ Warp™ Developer Kit, Java™ Edition, Version 1.1.7, and IBM OS/2 Warp Developer Kit, Java Technology Edition, Version 1.1.8. Although the page display is not precisely correct, the passwords will reset, but it is difficult to see what screen areas to “click” on when information is being submitted. Furthermore some functionality is lost when viewed in an OS/2 browser. To identify the pages that need modification, each page in the application is examined to determine what problems exist. Pages that require changes are modified to use more generic programming languages such as HTML (Hyper-Text Mark-up Language) or a supported version of JAVA. Some incorrectly displayed elements are merely cosmetic and are used only for the purpose of improving the appearance of the user interface. Other features are navigational and are used to go through the application, for example the HNEA application. The reason that there may be a conflict is that JavaScript 1.2 may handle the navigational components in a different manner than the supported browser version of Java 1.1.8, for example. In the latest releases of JavaScript 1.2, there are some functions that have been added that will not be understood by Java 1.1.8. Thus, these functions and classes will not be compiled correctly. If the failing features are navigational, they are re-coded to conform to Java 1.1.8. The same is true with regard to any other failing component of HNEA for example. The failing cosmetic features can be removed leaving the functionality in place. The above described methodology is illustrated in FIG. 3.

As shown in FIG. 3, the methodology begins 301 by identifying the various program features 303 which comprise a displayed page for example. Next, the navigational features are separated from the merely cosmetic features 305. After separation of the features 305, each feature is examined and modified to conform to a reference code 307 and the process is ended 309. As an example, in one application, navigational features written for JavaScript may be modified or re-coded to be compatible with Java 1.1.8.

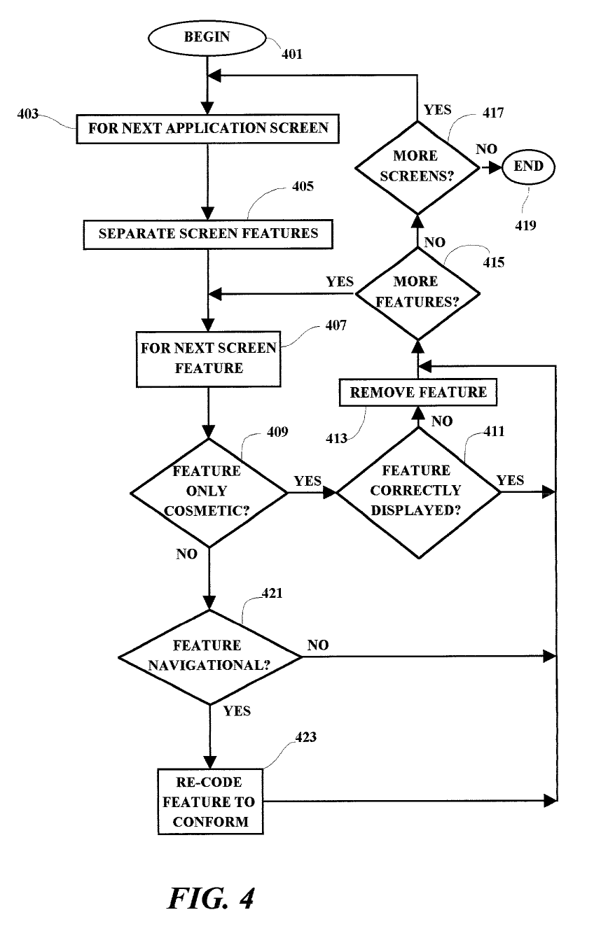

As shown in more detail in FIG. 4, when the process begins 401, for each application screen 403, the screen features are separated into cosmetic only features and navigational features 405. Next, for each screen 407, a check is made to determine if the feature is only cosmetic 409, i.e., for example, that the feature has no functional purpose in the application being examined but is used only to enhance the user interface. If the feature is only cosmetic 409, a check is made to determine if the feature is correctly displayed 411. If the feature is not correctly displayed 411, the feature is removed 413 and a check is made to determine if there are more features 415 on the screen being examined. If there are more features 415, the processing continues with the next feature 407. If there are no more features 415, a check is made to determine if there are more screens to be analyzed 417. If there are more screens 417, the processing continues with the next screen 403, otherwise the processing ends 419. If it had been determined at step 411 that the feature being examined is correctly displayed, then the processing continues by checking for the next feature 415. If it had been determined at step 409 that the feature being examined is not merely cosmetic 409, then if the feature is determined to be navigational 421, the feature is re-coded 423 to conform to the reference code as noted above, and the processing returns to check for the next feature 415. If the feature being examined is neither merely cosmetic 409 nor navigational 421, then the process returns directly to block 415 to check for the next feature. When it is determined that there are no more features or screens to be modified in accordance with the disclosed methodology, the processing ends 419.

The method and apparatus of the present invention has been described in connection with a preferred embodiment as disclosed herein. The disclosed methodology may be implemented in many different ways in order to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may be implemented partially or totally in program code stored on one of many possible media carriers, or other memory device, from which it may be accessed and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for conforming application software features to system support code, said method comprising:
separating navigational features of said application software from cosmetic features of said application software; and
separately modifying said navigational features and said cosmetic features to conform to said system support code.

2. The method as set forth in claim 1 wherein said navigational features are re-coded to conform to said system support code.

3. The method as set forth in claim 1 wherein said modifying of said cosmetic features comprises removal of said cosmetic features.

4. The method as set forth in claim 3 wherein said navigational features are re-coded to conform to said system support code.

5. The method as set forth in claim 1 wherein said application software is selectively operable to present a predetermined number of application screens on a display device, said separating being accomplished by reading navigational and cosmetic features of one screen at a time.

6. The method as set forth in claim 5 wherein for each screen presentation effected by said application software, said navigational and cosmetic features are checked one feature at a time.

7. The method as set forth in claim 1 wherein said modifying includes re-writing said application software to provide a replacement code, said replacement code being more generic than said system support code.

8. The method as set forth in claim 7 wherein said replacement code is Hyper Text Mark-up Language (HTML).

9. The method as set forth in claim 7 wherein said replacement code is an earlier version of said system support code.

10. The method as set forth in claim 9 wherein said system support code is a version of Java.

11. The method as set forth in claim 10 wherein said system support code is JavaScript.

12. The method as set forth in claim 11 wherein said replacement code is an earlier version of JavaScript.

13. The method as set forth in claim 12 wherein said earlier version is Java 1.1.8.

14. The method as set forth in claim 13 wherein said application software is a password processing program.

15. A computer system comprising:
a system bus;
a processing device connected to said system bus;
a memory device connected to said system bus; and
a display device connected to said system bus, said computer system being selectively operable for running application software, said application software being dependent upon system support code, said application software being selectively operable for effecting presentations of application screens on said display device, said application screens including both navigational and cosmetic features, said computer system being further effective for separating navigational features of said application software from cosmetic features of said application software, and separately modifying said navigational features and said cosmetic features to conform to said system support code.
